(19) United States
(12) Patent Application Publication
(10) Pub. No.: US 2016/0029648 A1
(43) Pub. Date: Feb. 4, 2016

(54) DEVICE FOR VOLUMETRICALLY MEASURING A SLAUGHTER ANIMAL BODY OBJECT

(71) Applicant: CSB-SYSTEM AG, Geilenkirchen (DE)

(72) Inventor: PETER SCHMITZEK, GEILENKIRCHEN (DE)

(21) Appl. No.: 14/776,850

(22) PCT Filed: Mar. 14, 2014
(86) PCT No.: PCT/DE2014/000123

§ 371 Date: Sep. 15, 2015

(30) Foreign Application Priority Data
Mar. 15, 2013 (DE) 20 2013 002 484.4

(51) Int. Cl. A22B 5/00; G01B 11/22; G06K 9/52; H04N 9/04; G01B 11/28; G06T 7/60; G01B 11/14; G06T 7/00

(52) U.S. Cl. CPC A22B 5/007; G01B 11/14; G01B 11/22; G06T 7/0065; H04N 9/045; G01B 11/28; G06T 7/602; G06K 9/52; G06T 2207/30244

(57) ABSTRACT

The invention relates to an apparatus for volumetrically measuring an object in the body of an animal for slaughter. The apparatus has a first depth camera with a first depth camera recording area, a second depth camera with a second depth camera recording area and has a positioning apparatus for positioning the depth cameras relative to one another. The apparatus has an evaluation unit. The evaluation unit is connected to the depth cameras, and acquires the spatial coordinate data provided by the depth cameras. The spatial coordinate data from the depth cameras can be combined as combined spatial coordinate data in a common spatial coordinate system. A surface model of the object in the body of an animal for slaughter is provided from the combined spatial coordinate data, and a volume of the object in the body of an animal for slaughter is calculated from the surface model.

The invention relates to a device for measuring a slaughter animal body object, particularly for assessing a slaughter yield.

From the prior art methods for determining the volume of a slaughter animal body object are generally known.

A common procedure is, for example, to hang a slaughter animal body from a weighing system, to determine its weight and, on the basis of the weight and predetermined model data, to make statements about the existing volume of the slaughter animal body and about the yield that can be expected.

However, this method has the particular disadvantage that the volume and the slaughter yield to be expected can only be roughly estimated on the basis of the model data provided. In this method, it is mostly ignored that each slaughter animal body has different expanses of tissue, meat, bone and fat tissue sections in particular, and therefore an exact statement about the most likely slaughter yield of meat of the slaughter animal body cannot be made.

Another option for assessing the slaughter yield of a slaughter animal body is described in DE 10 2004 047 773 A1.

According to this publication, the slaughter animal body is recorded by means of a tomographic technique and the disk-shaped segments of the slaughter animal body obtained in this way are assembled to produce a virtual model.

In this model, compartments of the meat, fat and bone tissue can be demonstrated and the volumes of each tissue compartment can then be determined.

In a next step, conclusions about the slaughter yield to be expected can be made on the basis of the volume data gathered.

The solution disclosed does in fact allow a very precise representation of the volumes and the yield to be expected from the slaughter animal body, but it requires immense technical effort and the measurement procedure thus involves enormous expense.

Moreover, the time-consuming tomographic procedure leads to a low throughput in the measurement of slaughter animal bodies.

Therefore, the object of the invention is to provide a device for volumetrically measuring a slaughter animal body object that allows a correct determination of the volumes of slaughter animal body objects and a reliable assessment of the slaughter yield to be expected at relatively low costs.

This object is achieved by the features described in the first claim. Preferred further embodiments result from the sub-claims.

Slaughter animal body objects according to the invented solutions can be, in particular, complete slaughter animal bodies, slaughter animal body halves or parts thereof such as ham.

An invented device for volumetrically measuring a slaughter animal body object comprises a depth camera with a first depth-camera recording range, in which a section of a surface of the slaughter animal body object on a first side can be optically recorded and in which space coordinates of image points on the first side of the slaughter animal body object can be recorded.

According to the invention, the section of the surface of the first side can be either a subsection of the surface or the complete surface of the first side.

The space coordinates of the recorded image points are composed of their area coordinates (x, y) and a depth value (z).

The first depth camera is additionally capable of providing the space coordinates of the registered image points in the section of the surface of the first side as space coordinates for transfer purposes.

Moreover, the device of the present invention comprises a second depth camera with a second depth-camera recording range, in which a section of a surface of the slaughter animal body object on a second side can be optically recorded and in which space coordinates of image points can be recorded on the second side of the slaughter animal body object.

According to the invention, the section of the surface of the second side can be either a portion of the surface or the complete surface of the second side.

The space coordinates of the recorded image points are, according to the invention, in this case also composed of their area coordinates (x, y) and a depth value (z).

The second depth camera is additionally capable of providing the space coordinates of the registered image points in the section of the surface of the second side as space coordinates for transfer purposes.

Furthermore, the inventive device includes a positioning device for positioning the first depth camera relative to the second depth camera, and the depth-camera recording ranges of the first and second depth cameras are determined by this positioning.

Preferentially, the depth cameras are positioned in relation to each other in such a manner that their optical axes run antiparallel to each other and, provided that the slaughter animal body object has an appropriate size and is in a sufficiently central position between the depth cameras, the recording range of the first depth camera is covered to such an extent by the slaughter animal body object that the second depth camera does not influence the recording range of the first depth camera. This shall equally apply the other way round, i.e. that the first depth camera does not influence the recording range of the second depth camera.

In this way, measuring inaccuracies due to the mutual interference of the depth cameras can be avoided.

The slaughter animal body object is preferably moved past the depth cameras by means of a transport system in such a manner that the slaughter animal body object crosses the depth-camera recording ranges.

The transport system mainly used for such slaughter animal bodies are roller hooks or band-conveyors.

The image points are recorded in real time and simultaneously by the first and the second depth camera. Simultaneously means in this context that the slaughter animal body object is not or only slightly moved between the recording by the first depth camera and the one by the second depth camera so that a combination of the area coordinates (x, y) of the image points recorded by both cameras in a common space coordinate system remains possible.

The real time capability of the two depth cameras particularly accounts for a high image recording rate, i.e. that the depth cameras are capable to record space coordinates in the depth-camera recording ranges simultaneously.

The inventive device moreover comprises an evaluation unit that is connected to the first and the second depth cameras. The connection between the evaluation unit with the depth cameras can be designed with or without wires and allows the transfer of the space coordinates to the evaluation unit.

According to the invention, the evaluation unit is capable of registering the space coordinate data provided by the first and second depth cameras and of combining the registered space coordinate data to produce merged space coordinate data in a common space coordinate system.

The common space coordinate system is a three-dimensional coordinate system, specifically a Cartesian coordinate system with the orientation axes x, y, z, in which at least the position of the two depth cameras and their orientation to each other are known.

Moreover, the evaluation unit is advantageously capable of providing a surface model of the slaughter animal body object from the space coordinate data combined in the common space coordinate system.

For this purpose, the combined space coordinate data of the first and second sides of the slaughter animal body object are intermeshed to generate a net-like surface model of the animal body object.

Afterwards, volumes of the slaughter animal body object are calculated on the basis of the surface model generated.

With respect to the necessary evaluation effort, the number of space coordinate data required is preferentially selected such that a sufficiently exact determination of the relevant volumes of the slaughter animal body object is ensured.

Thus, the invented device makes it possible to determine the volumes of a slaughter animal body object in a particularly simple way and, compared to conventional methods, a considerably improved measurement accuracy and a higher throughput rate as well as lower costs for the measuring procedure can be achieved.

Another advantage of the invented device is that during a measurement the correct distance of the slaughter animal body object to the depth cameras is not absolutely necessary because the distance information can already be provided per se by the depth value. Thus, additional equipment otherwise required for the exact positioning of the slaughter animal body object is no longer necessary.

In an advantageous further embodiment geometric models are saved in the evaluation unit. These models are mathematical abstractions of parts of a normative slaughter animal body object, for example of a hind leg of a pig half. Such a model is not necessarily defined in a scalar manner and has been created from average values that have been established by cutting tests. Therefore, the geometric model is not determined by the slaughter animal body object to be measured.

In contrast to this, the surface model is an abstraction determined by the slaughter animal body object that is actually to be measured.

If the device detects defined points of a geometric model as measuring points on the slaughter animal body object, it is possible, by including the geometric model, to determine a volume of the part of the slaughter animal body, for example of a hind leg of a pig half, that corresponds to the geometric model. This is then a partial volume of the slaughter animal body object. The surface model can be included optionally to calculate the relations of volumes and partial volumes on the one hand and to support the detection of the defined points of a geometric model on the other hand.

This advantageous embodiment is particularly based on the fact that the invented device makes it additionally possible to determine distinctive structures on the surface of one side of the slaughter animal body object by means of the first or second depth camera and the space coordinate data provided by them and transferred into the common space coordinate system.

Such distinctive structures can be, for example, forelegs and/or hind legs of the slaughter animal which distinguish themselves due to their shape from the surface of the slaughter animal body object. These distinctive structures are used to determine the measurement points and assigned to the defined points of the appropriate geometric model.

In an advantageous embodiment of the invention, the device is additionally equipped with at least one image camera.

The image camera has an image-camera recording range in which a relevant section of a surface of the slaughter animal body object is recordable on the first side and in which light intensity values of image points and their area coordinates can be recorded on the surface of the slaughter animal body object on the first side.

The image camera recording range is, for example, designed such that in the relevant section the complete surface of the slaughter animal body object on the first side can be recorded. Depending on the application, it is also possible that only a subsection of the surface of the first side of the slaughter animal body object is recorded.

The preferred embodiment described is particularly advantageous if the surface of the first side is a cutting-side surface of an animal body half. In order to ensure that the image camera provides a successful record of the relevant section of the surface on the first side of the slaughter animal body object, the slaughter animal body object is positioned according to the invention in such a manner that the relevant section of the surface on the first side of the slaughter animal body object is at least sufficiently turned towards the image camera.

According to the invention, the image camera is a 2D-camera and within the image camera recording range it enables the recording of light intensity values (g) of image points as well as of area coordinates (x, y) of the image points in the relevant section of the surface of t e first side of the slaughter animal body object.

The light intensity values can be recorded, for example, in a usual manner by determining gray scale values.

In this way it is for example possible to output a light gray scale value for fat tissue and a dark gray scale value for meat tissue possibly contained within the relevant side of the surface of the slaughter animal body object.

Preferentially, the image camera is aligned such that its center axis, hereinafter also referred to as a measurement standard, is positioned as far as possible in a right angle relevant to the movement axis of the slaughter animal body object.

In this arrangement, the center axis is the optical axis of the image camera, whereas the movement axis of the slaughter animal body object refers to the axis on which the slaughter animal body object is moved through the image-camera recording range and the deep recording ranges.

Another feature is that the image camera according to this invention can provide the light intensity values of the image points and the area coordinates assigned to them as light intensity value data for transfer purposes.

According to the invented further embodiment, the positioning device determines the position of the image camera relative to the first depth camera in such a way that the image camera recording range and the first depth camera recording range overlap in a common recording range at least in certain sections, and the image points of the relevant section of the surface to be evaluated by the evaluation unit are located in the common recording range.

Depending on the arrangement of the image camera and the first depth camera in relation to each other, for example, a horizontal or a vertical arrangement, the first depth camera recording range and the image-camera recording range can partly overlap either horizontally or vertically.

Preferentially, the recording ranges of the first depth camera and the image camera and their positioning in relation to each other is defined such that the common recording range is as large as possible in order to utilize the resolution of the first depth camera and image camera in the best possible way.

In the device of the present invention, the image points on the surface of the first side of the slaughter animal body object are recorded in real time and simultaneously by the image camera and the first depth camera. Simultaneously means in this context that the slaughter animal body object is not or only slightly moved between the recording made by the image camera and that made by the first depth camera so that an assignment of the area coordinates (x, y) of the image points recorded by the image camera and first depth camera to each other remains possible.

The real time capability of the depth camera particularly results in a high image rate so that the first depth camera is capable of recording space coordinates in the recording range of the first depth camera simultaneously, an advantage that can be guaranteed, for example, by TOF cameras.

The device of the present invention is moreover characterized by the fact that the image camera is also connected to the evaluation unit and the evaluation unit registers and processes the light intensity value data provided by the image camera.

According to the invention, the connection between the image camera and the evaluation unit can also be designed with or without wires and allows the transfer of the light intensity value data to the evaluation unit.

According to the invention, the evaluation unit can assign the light intensity value data of image points provided by the image camera to the space coordinate data of image points provided by the first depth camera if they have common area coordinates (x, y). By means of the data delivered by the image camera and the first depth camera, image points are provided in the common recording range for which both the area coordinates (x, y) and the light intensity value (g) and the depth value (z) are registered, and the area coordinates from the light intensity value data and the area coordinates from the space coordinate data are identical.

It is particularly advantageous if the assigned light intensity value and space coordinate data are provided as data tuples (x, y, z, g).

Furthermore, the evaluation unit according to this invention is also capable of identifying defined measurement points on the surface of the first side of the slaughter animal body object from the light intensity value data of the image points provided by the image camera. In this case, the first side is preferentially a cutting side of a slaughter animal body half. The identification of measurement points means that characteristic structures on the preferentially cutting surface of the slaughter animal body object, for example muscles, fat tissue or bones, are detected by the evaluation unit by applying image analysis and object identification processes. For this purpose, different tissue sections are computationally detected and selected on the basis of the differences in light intensity values in order to determine the contours of muscles, fat and bones by means of a contour-tracking algorithm.

On the basis of these characteristic structures, points are defined, the position of which in relation to each other makes it possible to reach conclusions about the quantities and qualities of the slaughter animal body object. The area coordinates of these points are determined as measurement points by the evaluation unit and form the basis for further measurements and for the expectable slaughter yield.

The space coordinate data of the data tuple of a first measurement point and the space coordinate data of the data tuple of a second measurement point make it possible to determine the distance from one measurement point to the other in the space.

Depending on the requirement, this method makes it possible to determine the spatial Euclidian distance of the measurement points to one another or their distance from one other on the surface in the relevant section of the preferentially cutting-side surface of the slaughter animal body object, and the distances of the measurement points on the relevant section of the preferentially cutting-side surface are determined by an integration of the spatial distances of sufficiently small partial distances of the total distance.

Moreover, in this way it is also possible to determine areas within the surface of the relevant sections of the preferentially cutting-side surface via an integration of sufficiently small, spatially exactly calculated partial areas, if a sufficient number of measurement points is provided.

In both cases, measurement errors due to uneven or bent surface areas can be successfully avoided by such a procedure. Depending on the complexity of the relevant surface of the slaughter animal body object, it can further be useful to smooth the optically recorded surface locally to improve the measurement accuracy, in particular by including the depth values of the pixel neighborhood, and to calculate the distance values of the measuring points on the smoothed surface in the sense of a model with an ideal cutting-side surface.

For a sufficient number of relevant measurement points it is also possible to perform area measurements in addition to line segment measurements, and as a result statements can be made regarding the composition of the slaughter animal body object, for example lean meat, fat tissue and bone proportions, about the position of organic structures, etc. Quantitative and qualitative classification statements and cutting decisions can be derived from this information.

Depending on the resolution of the depth and image camera, the image points of the cutting-side surface of the slaughter animal body half are present in a defined number of pixels. The image data are combined by means of the evaluation unit, even for different resolutions of the depth camera and the image camera, in such a way that, apart from the area coordinates, the light intensity value and the depth value are provided for each pixel by the combined light intensity value data and space coordinate data.

In addition to this, in the invented device the measurement points identified are assigned to the generated surface model of the slaughter animal body object on the basis of their space coordinate data.

In a particularly advantageous manner, partial volumes of the slaughter animal body object can be subsequently calculated by including the space coordinates of the measurement points identified. For this purpose, the corresponding tissue section is measured by including the space coordinates of the measurement points and previously determined geometric models which contain a dependence of the tissue section dimensions relative to the volume of the part of the slaughter animal body object and optionally to the total volume of the slaughter animal body object are saved in the evaluation unit.

By including the measured measurement points and the points defined in the geometric models, the geometric models are assigned to the specific tissue section to be measured, and the expected partial volume for every relevant tissue section is then determined from the assigned data.

The geometric models are generated on the basis of the organic structures of the slaughter animal body object which can be determined with great precision, for example, by cutting tests or computer tomography.

The geometric models are to be understood as virtual components of the slaughter animal body object and said virtual components can be put together to form a modular structure. The specific advantage of the inclusion of the geometric models is the fact that the data density and precision, which are particularly achievable by computer tomography, are aggregated in the geometric models and thus can be integrated into a real-time capable system without the necessity in each case to always “in-line” computer tomographies, which are expensive, slow and involve with radiation emission. And the space coordinate data determined by the depth cameras allow a high assignment reliability of the individual geometric models.

A further way to improve precision is to take the measurement points, which have been determined on the basis of data tuples with light intensity value data and space coordinate data, to form specific sections of the slaughter animal body and to use space coordinate data to generate a surface model of this section and to consider the volume of this section thus determined. In this way it is possible, for example, to cut a slaughter animal body half into virtual disks positioned transversally relative to the cutting surface and the thickness and position of said discs are defined by the length of one vertebra that has been optically identified. The spatial dimensions of the surface sections belonging to the virtual disc are now determined by the depth cameras. The volume of the virtual disc thus specified allows greater accuracy in predicting, for example, the proportion of lean meat, because different breeds and genetics mainly differ in their total proportion and less in local combinations.

This method offers the particular advantage that the measurement of a slaughter animal body object with a volume determination of the relevant tissue sections is made possible by a device according to the invention and on the basis of the results obtained the expectable slaughter yield can be reliably prognosticated.

A further advantage of the device is the high measurement accuracy because possibly existing irregularities in distance and angle, for example due to the positioning of the slaughter animal body object and, in the case of a cutting side of a slaughter animal body half as a first side of a possibly not even cutting-side surface, a possibly uneven cutting-side surface can be corrected by the registered depth value.

Simultaneously, the components used in the invention make it possible to keep the provision and application costs of such a device low and ensure a high throughput of slaughter animal body objects to be measured.

Moreover, due to the inclusion of the individual depth value in the present invention, it is not absolutely necessary to maintain an exactly predefined distance or exactly predefined angle of the slaughter animal body object relative to the device, because the distance information can already be provided by the depth value. Thus, additional equipment otherwise required for the exact positioning of the slaughter animal body object or for the correction of unevenness is no longer necessary. Consequently, the provision and operating costs of a device according to this invention are comparatively low.

Furthermore, measurement can be carried out without any contact with the slaughter animal body object and thus hygiene risks caused by additional equipment known from the prior art for the positioning of slaughter animal body objects are avoided and additional hygiene measures are not required.

The advantages described also apply accordingly to the measurement of other slaughter animal body objects which can, for example, be transported on a conveyor belt. It is true that the problem of uncontrolled movements does not exist if conveyor belts are used. Nevertheless, the invented solution offers a particular advantage even for these cases because the positioning of the slaughter animal body object relative to the conveyor belt, particularly transversely to the length of the conveyor belt, can be inexact and the device of the present invention already provides the distance information through the depth value. The distance data not only provide information about the position of the slaughter animal body object relative to the image camera but also relative to the conveyor belt. As the motion and positioning of the conveyor belt can be exactly controlled, it is also possible, in case of further transport to a down-stream station, to pre-determine a position of the slaughter animal body object relative to the elements of such a station, for example a cutting robot, and to control the other element according to the known position without requiring new data to be recorded.

Preferentially, the device also comprises units for illuminating the slaughter animal body object, and the light color is advantageously selected such that a good image point recording by the image camera and the depth cameras will be possible.

In a further particularly advantageous embodiment of the invention, the image camera is a chromaticity camera.

The use of a chromaticity camera enables the operator to register the light intensity values separately according to individual color channels, specifically Red, Green and Blue (RGB), and to provide the light intensity values separated according to color channels in the light intensity value data and to transfer them to the evaluation unit. The light intensity values can then be used according to the color channels for the image analysis and thus contours of structures on the cutting-side surface of the slaughter animal body object can be better identified.

In this way, the measurement accuracy achieved by the device of the present invention can be additionally optimized.

In a further advantageous embodiment of the invention, the slaughter animal body object is a slaughter animal body half which has a cutting side and the section of the surface of the first side is the surface of the cutting side, and the surface of the cutting side of the slaughter animal body half can always be optically captured both by the image camera recording range and the recording range of the first depth camera. This further design is particularly advantageous if the device according to the aforementioned further design is additionally equipped with an image camera that optically records the cutting side because the exposed organic structures facilitate the identification of defined measurement points by means of light intensity value data.

In this case, a rough positioning ensures that the cutting side is sufficiently orientated towards the image camera. However, even here the advantage is provided that an exact positioning with respect to distance and angle is not required.

In this advantageous embodiment it is also furthermore possible for distinctive structures on the second side, i.e. the rear side of the slaughter animal body half, to be determined by the second depth camera and by means of the space coordinate data provided and transferred to the common space coordinate system by this camera. Such distinctive structures can be, for example, forelegs and hind legs of the slaughter animal body object that are distinguished from the rear side of the slaughter animal body object by their shape.

Moreover, in a further advantageous embodiment of the invention the depth value from the individually determined space coordinates is used for identifying measurement points on the relevant surface of a slaughter animal body object.

Thus, the measurement points can be better identified by including the depth value information, in particular for an uneven cutting-side surface of a slaughter animal body half. This is particularly the case if a characteristic structure, for example at the transition of a cutting plane into the abdomen, can be better detected by the depth information than by the light intensity value data.

In this case, the recordable depth value takes on a dual function by providing the space coordinates of the measurement points identified from the light intensity value data of the image points and, in addition to this, by allowing or at least supporting the foregoing identification of the measurement points, in particular on the cutting-side surface of the slaughter animal body half.

In a particular manner, the depth information can also be used to distinguish the slaughter animal body object from the background and thus to define its contour. Depth values that lie outside a defined range, especially depth values above a defined range, are then assigned to the background per se by an evaluation algorithm without requiring the additional inclusion of the light intensity value data.

This method makes it possible to dispense with background walls that are normally used in the prior art.

A further advantageous embodiment addresses a frequently occurring problem which is that the real surface shape and an ideal model-like shape of the slaughter animal body object are not identical. In slaughter animal body halves the cutting-side surface, for example, is an exact plane in the model-like ideal shape. The model-like distances of measuring points are based on the model-like ideal shape. The deviation of the real surface shape from the model-like ideal shape leads to inaccuracy in the significance of statements about the distances of the measurement points in the space based on the real surface shape.

It is one of the advantages of the invention that the distance information, i.e. the z-value of the space coordinates, provided in any case by the depth camera, can also be used to solve this problem.

Provided the areas with deviations are known, in particular if they are always at the same location due to anatomical or technical conditions, the depth values of points within these areas may be excluded or weighted less a priori for the creation of the model-like ideal surface. If they are not known, such points are detected from a plurality of points which show a deviation greater than a defined value from the ideal model defined by most of the other points and which on this basis are excluded or weighted less. Known methods, such as RANSAC, can be used for the model adjustment and outlier detection.

On the basis of the model-like ideal surface shape created in this way, in the case of a slaughter animal body half of the plane, the space coordinates of the measurement points determined are projected onto the ideal model surface according to the previous model-related knowledge. Based on the space coordinates provided in this manner, the distance of the measurement points in the space are then determined.

In a further particularly advantageous embodiment of the invention, the depth camera is a TOF (Time-of-flight) camera.

A TOF camera allows in a manner known per se to determine a distance between itself and a recorded object by applying a transit time technique.

In this method, the recorded object is illuminated by a light pulse and the camera determines for each illuminated image point the time which the light needs to reach the object and from the object back to the camera.

The use of a TOF camera offers several advantages.

First, TOF cameras normally have a simple design and therefore they can be provided at relatively low costs.

Secondly, high image rates can be achieved by TOF cameras, because the complete object is recorded in one image in a very short time.

Therefore, TOF cameras are particularly useful for the real-time application intended by the invention.

Moreover, an advantageous embodiment of the invented device comprises at least an additional depth camera with an additional depth-camera recording range in which a section of a surface of a slaughter animal body object can be optically recorded and in which further space coordinates of image points, consisting of area coordinates and a depth value, can be recorded, and the further space coordinates can be provided as space coordinate data for transfer purposes. In this arrangement, the evaluation unit is connected to the additional depth camera and registers the space coordinate data provided by the additional depth camera, and the space coordinate data of the additional depth camera can be combined with the space coordinate data of the first and second depth cameras as combined space coordinate data in the common space coordinate system.

According to the invention, the additional depth camera can be positioned such that its depth-camera recording range can record additional areas of the slaughter animal body object. In this case, the further invented embodiment makes it possible to enlarge the recordable sections and/or to improve the resolution.

Furthermore, the additional depth camera can be positioned in such a manner that, although it records the slaughter animal body object in the same section as the first and second depth cameras, it does it at a different angle and thus captures or better captures, for example, concave formations, particularly in slaughter animal body halves.

This means that the depth-camera recording range of the additional camera and the recording range of the first or second camera overlap at least in certain sections.

According to the invention it is also possible to position the additional camera such that its depth-camera recording range is mostly identical with the recording range of the first or second depth camera but offers a higher resolution.

This arrangement allows, for example, the recording of specifically relevant sections of the slaughter animal body object as sections with a correspondingly higher resolution.

In this respect the present invention also offers the possibility of providing a large number of additional depth cameras in order to provide an effective multi-recording of, in particular, complex slaughter animal body objects.

In each case, the space coordinate data, which are captured by the additional depth camera or the additional depth cameras, are registered and combined with the space coordinate data provided by the first and second depth cameras as combined space coordinate data in the common space coordinate system and further processed.

A further advantageous embodiment of the invented device comprises at least an additional image camera with an additional image-camera recording range in which a section of a surface of the slaughter animal body object can be optically recorded and in which light intensity values of image points and their area coordinates can be registered. These light intensity values and the area coordinates assigned to them can be provided as light intensity value data for transfer purposes, and the positioning device sets the position of the additional image camera relative to one of the depth cameras so that the recording range of the additional image camera and the depth-camera recording range of the depth camera overlap at least partially in an additional common recording range, and the additional image camera is connected to the evaluation unit which can register and further process the light intensity value data provided by the additional image camera.

The light intensity value data are registered and further processed analog to the features mentioned and described in claim 3.

Here, the present invention also offers the possibility of providing a large number of additional image cameras within the arrangement in order to present the advantage that all relevant surfaces of a slaughter animal body object are recorded by image cameras.

In the following, the invention is explained as an embodiment in more detail by means of the following figures. They show:

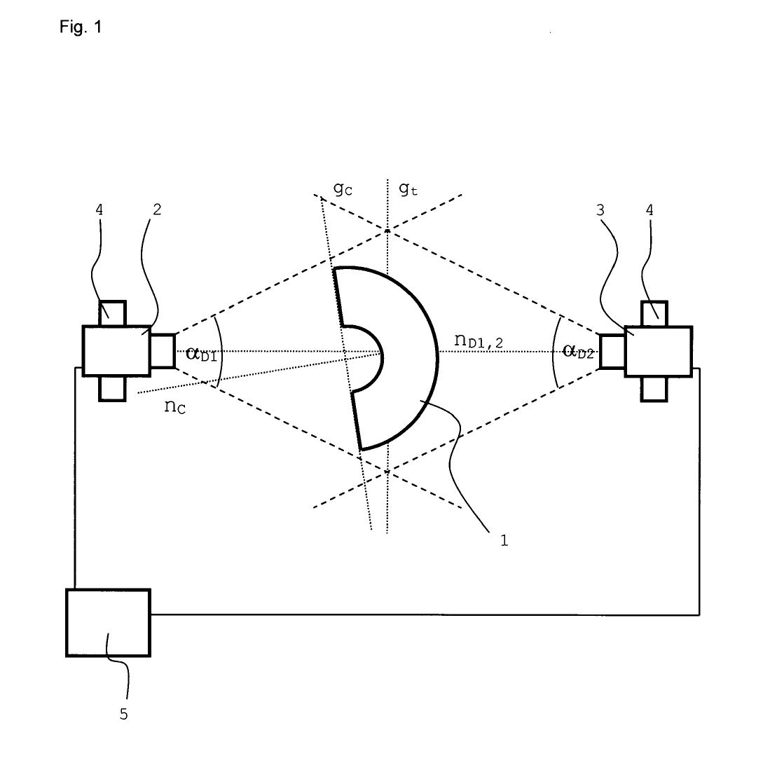

FIG. 1 schematic drawing with two depth cameras

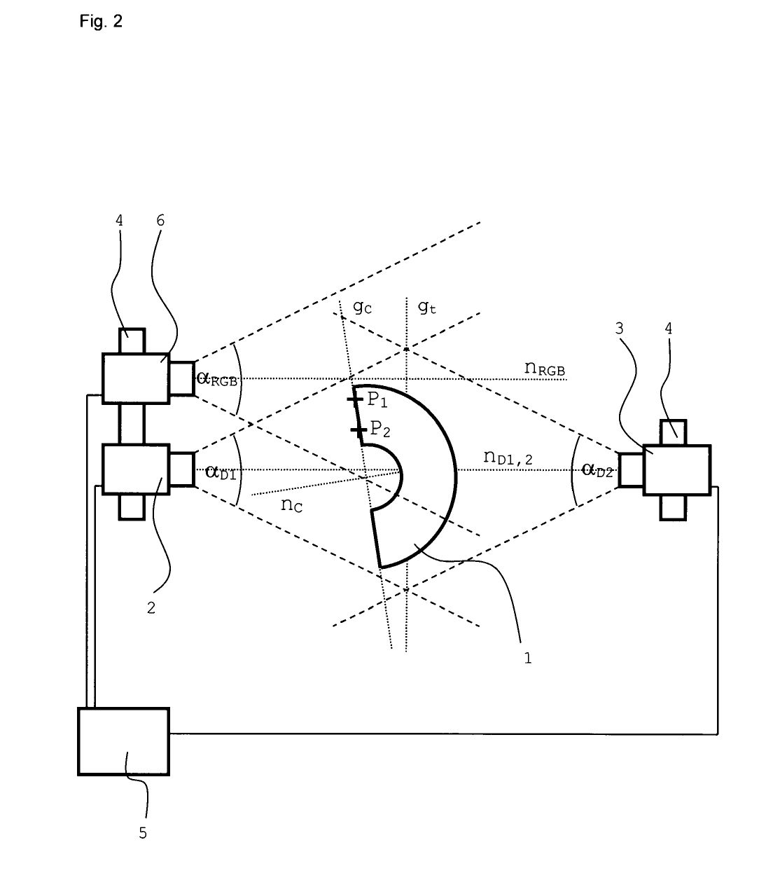

FIG. 2 schematic drawing with an additional image camera.

This embodiment is a device for measuring a slaughter animal body object 1 in the form of a slaughter animal body half.

According to FIG. 1, an invented device embodiment for volumetrically measuring a slaughter animal body half comprises a first depth camera 2 and a second depth camera 3.

The slaughter animal body half is positioned centrally between the depth cameras 2 and 3 and is moved along a movement axis gₜ past the depth cameras 2 and 3 on by a transport unit (not represented).

The slaughter animal body half comprises a first side and a second side with the first side being a cutting side and the second side being a rear side in opposite position to the cutting side.

The cutting side is illustrated by the plane axis g_{C}.

The depth cameras 2 and 3 each have a depth-camera recording range and the depth-camera recording range of the first depth camera 2 is illustrated by the recording angle α_{D1} and the depth-camera recording range of the second depth camera 3 is illustrated by the recording angle α_{D2}.

According to the invention, the depth cameras 2 and 3 are positioned above a positioning device 4 such that the depth-camera recording ranges are opposite to each other and the depth cameras 2 and 3 for a common standard line n_{D1,2}.

The depth cameras 2 and 3 are particularly advantageously positioned in such a manner that the common standard line n_{D1,2} is orientated perpendicularly to the movement axis gₜ of the slaughter animal body half.

According to FIG. 1 and FIG. 2, the depth cameras 2 and 3 are designed as TOF (Time-of-flight) cameras in the present embodiment.

In the invented arrangement, the depth cameras 2 and 3 are connected to an evaluation unit 5.

In the invented embodiments according to FIG. 1 and FIG. 2, the depth cameras 2 and 3 are capable of recording at least partially, in the respectively assigned depth-camera recording range, the surface of the side of the slaughter animal body half facing them.

According to the invention, the first depth camera 2 can record the surface of the first side of the slaughter animal body half and therefore record the cutting side, whereas the second depth camera 3 can record the surface of the second side of the slaughter animal body half, i.e. the rear side.

Within their individual depth-camera recording ranges, the depth cameras 2 and 3 can further record space coordinates of image points on the corresponding surface of the slaughter animal body half, and all these space coordinates are composed of area coordinates (x, y) and a depth value (z).

The recorded space coordinates are transferred by the depth cameras 2 and 3 to the evaluation unit 5.

The evaluation unit 5 registers the space coordinates transferred by the depth cameras 2 and 3 and further processes them such that the space coordinates registered are combined in a common space coordinate system (not represented).

The common space coordinate system is a three-dimensional Cartesian coordinate system with the orientation axes X, Y, Z, in which at least the position and orientation of the depth cameras 2 and 3 are known.

The evaluation unit 5 uses the space coordinates transferred by the depth cameras 2 and 3 to generate a surface model (not represented) of the slaughter animal body half within the common space coordinate system, with the space coordinates being intermeshed to a virtual network.

On the basis of the generated surface model of the slaughter animal body half, it is further advantageously possible to determine volumes of the slaughter animal body half.

In a further embodiment according to FIG. 2, the invented device additionally comprises an image camera 6 with an image-camera recording range illustrated by the recording angle α_{RGB}.

The image camera 6 can be positioned by the positioning device 4 so that the image-camera recording range and the depth-camera recording range of the first depth camera 2 overlap at least in specific sections.

Moreover, the image camera 6 and the slaughter animal body half are positioned relative to each other in such a manner that the cutting-side surface of the slaughter animal body half is at least sufficiently turned towards the image camera 6 so that the cutting-side surface of the slaughter animal body half can be successfully recorded by the image camera 6.

In this arrangement, the image camera 6 is preferentially orientated so that its standard line n_{RGB} is positioned in a right angle to the movement axis gₜ of the slaughter animal body half.

The image camera 6 is designed as an RGB camera and is, according to the invention, capable of recording the cutting-side surface of the slaughter animal body half at least partially within the image-camera recording range.

Furthermore, light intensity values (g) of image points and their area coordinates (x, y) can be captured at the cutting-side surface of the slaughter animal body half by the image camera 6 within the image-camera recording range.

The image camera 6 further combines the light intensity value data and area coordinates to light intensity value data (x, y, g) and provides them for transfer purposes.

According to the invention, the image camera 6 is also connected to the evaluation unit 5 which registers and further processes the light intensity value data transferred by the image camera 6.

According to the invention, the light intensity value data are further processed by the evaluation unit 5 in such a manner that the evaluation unit 5 identifies defined measurement points P₁, P₂ on the cutting-side surface of the slaughter animal body half from the light intensity value data of the image points recorded.

The identification of measurement points means in this case that characteristic structures on the cutting-side surface of the slaughter animal body half, for example muscles, fat tissue or bones, are detected by the evaluation unit by applying image analysis and object identification processes. For this purpose, different tissue sections are computationally detected and selected on the basis of the differences of the light intensity values in order to determine the contours of muscles, fat and bones by means of an appropriate image processing algorithm.

On the basis of these characteristic structures, points are defined, the position of which in relation to each other makes it possible to reach conclusions about the quantities and qualities of the slaughter animal body half. The area coordinates of these points are determined as measurement points P₁ and P₂ by the evaluation unit.

The measurement points P₁, P₂ are located within the common recording range of the image camera 6 and the first depth camera 2.

Thus, the evaluation unit 5 is advantageously capable of assigning to the measurement points P₁, P₂ both their light intensity value data and their space coordinates.

As a particular advantage, the measurement points P₁, P₂ that have been identified can be assigned to the generated surface model by the evaluation unit 5 so that relevant tissue sections of the cutting-side surface of the slaughter animal body half can be additionally represented within the surface model.

On the basis of the additionally representable tissue sections of the cutting-side surface of the slaughter animal body half, sub-volumes of the slaughter animal body half can be determined as a further advantage.

For this purpose, geometric models are saved in the evaluation unit 5 and said models contain a dependence of the tissue section dimensions relative to the total volume of the slaughter animal body half.

Each of these geometric models is assigned to the corresponding tissue section to be measured and then the expectable sub-volume of the corresponding relevant tissue section is determined from the assigned data.

It is thus possible by means of the inventive device to give, in an extremely simple and, moreover, cost-effective manner, a more precise prognosis regarding the expected slaughter volume of the slaughter animal body half measured than is the case for devices known so far.

### LIST OF REFERENCE NUMERALS

1 slaughter animal body object
2 first depth camera
3 second depth camera
4 positioning device
5 evaluation unit
6 image camera
n_{D1,2} common standard line of the first and second depth camera
n_{C} standard line of the slaughter animal body half
g_{C} plane axis of the slaughter animal body half
gₜ movement axis of the slaughter animal body half
n_{RGB} standard line of the image camera
α_{RGB} recording angle of the image camera
α_{D1} recording angle of the first depth camera
α_{D2} recording angle of the second depth camera
P₁ first measurement point
P₂ second measurement point

1-10. (canceled)

11. A device for volumetrically measuring a slaughter animal body object, comprising:
a first depth camera having a first depth-camera recording range for optically recording a section of a surface of the slaughter animal body object on a first side and for recording space coordinates of image points on the first side of the slaughter animal body object, the space coordinates including area coordinates and a depth value, and the space coordinates being provided as space coordinate data for transfer purposes;
a second depth camera having a second depth-camera recording range for optically recording a second section of a second surface of the slaughter animal body object on a second side and for recording second space coordinates of second image points on the second side of the slaughter animal body object, the second space coordinates including second area coordinates and a second depth value, and the second space coordinates being provided as second space coordinate data for transfer purposes;
a positioning device for positioning the first depth camera relative to the second depth camera, and the first and second depth-camera recording ranges being determined by the positioning;
an evaluation unit connected with the first and the second depth cameras, said evaluation unit registering the first and second space coordinate data provided by the first depth camera and the second depth camera, said evaluation unit combining the first and second space coordinate data together as combined space coordinate data in a common space coordinate system, and said evaluation unit creating a surface model of the slaughter animal body object from the combined space coordinate data and calculating a volume of the slaughter animal body on the basis of the surface model.

12. The device according to claim 11, wherein said evaluation unit saves a geometric model and identifies measurement points in the section of the surface of the first or second side of the slaughter animal body from the space coordinate data and said evaluation unit assigns identified measurement points to defined points of the geometric model, and said evaluation unit calculates a sub-volume of the slaughter animal body by including the space coordinates of the measurement points.

13. The device according to claim 11, further comprising:
at least one image camera having an image camera recording range for optically recording a section of one of the first surface or the second surface of the slaughter animal body object and for recording light intensity values of image points and area coordinates of the image points, the light intensity values and the area coordinates being provided as light intensity value data for transfer purposes;
the positioning device determining the position of said at least one image camera relative to said first depth camera so that the image-camera recording range and the first depth-camera recording range overlap, at least in certain sections, in a common recording range;
said at least one image camera being connected to said evaluation unit, said evaluation unit registering the light intensity value data provided by said at least one image camera, said evaluation unit identifying measurement points on the section of the surface of the first side of the slaughter animal body object on the basis of the light intensity value data, and the light intensity value data and the space coordinate data of said first depth camera being associated via identical area coordinates, and the assigned light intensity value data and space coordinate data being provided as data tuples;
said evaluation unit assigning the measurement points to the surface model of the slaughter animal body and calculating a sub-volume of the slaughter animal body from the surface model by including the space coordinates of the measurement points.

14. The device according to claim 13, wherein said at least one image camera is a chromaticity camera, the light intensity values are registered separately according to color channels, and the light intensity values are provided separately according to color channels in the light intensity value data.

15. The device according to claim 13, wherein the slaughter animal body object is a slaughter animal body half having a cutting side, and the section of the surface of the first side is a surface of the cutting side, and both the image-camera recording range and the surface of the cutting side of the slaughter animal body half is optically captured both by the image camera recording range and the depth camera recording range.

16. The device according to claim 12, wherein, the depth value of individually determined space coordinates is used to identify a measurement point in the first section of the surface of the first side of the slaughter animal body object.

17. The device according to claim 11, wherein the depth value from the individually determined space coordinates of a large number of points on one of the sections of the surface of a slaughter animal body half is used for determination of a model-like ideal surface shape, and a distance of measurement points identified in the space is determined on the basis of a depth value that corresponds to the model-like ideal surface shape.

18. The device according to claim 11, wherein the depth cameras are TOF cameras.

19. The device according to claim 11, further comprising:
an additional depth camera with an additional depth-camera recording range for optically recording a section of a surface of the slaughter animal body object and for recording further space coordinates of image points, the further space coordinates including area coordinates and a depth value, and the further space coordinates being provided as space coordinate data for transfer purposes, said at additional depth camera being connected to said evaluation unit, said evaluation unit registering the space coordinate data provided by said additional depth camera, and said evaluation unit combining the space coordinate data of said additional depth camera with the space coordinate data of the first and second depth cameras as combined space coordinate data in the common space coordinate system.

20. The device according to claim 13, further comprising:
an additional image camera with an additional image-camera recording range for optically recording a section of a surface of the slaughter animal body object and for recording light intensity values of image points and area coordinates of the image points, the light intensity values and the area coordinates being provided as light intensity value data for transfer purposes, said positioning device setting a position of the additional image camera relative to one of said depth cameras so that the recording range of said additional image camera and the depth-camera recording range of a depth camera at least partially overlap in an additional common recording range, and said additional image camera being connected to said evaluation unit and said evaluation unit registering and further processing the light intensity value data provided by said additional image camera.
